(19) United States
(12) Patent Application Publication
(10) Pub. No.: US 2024/0282986 A1
(43) Pub. Date: Aug. 22, 2024

(54) METHOD AND MODULE FOR CONTROLLING A VALVE FOR REGULATING THE INTERNAL PRESSURE OF A FLUID CIRCUIT IN AN ELECTROCHEMICAL DEVICE

(71) Applicant: SAFRAN POWER UNITS, TOULOUSE (FR)

(72) Inventors: Kilian Frank, Claude BERNARD, MOISSY-CRAMAYEL (FR); Robin Jacques, Marie VIALET, MOISSY-CRAMAYEL (FR); Olivier Rafaël, René CRASSOUS, MOISSY-CRAMAYEL (FR); Rémi André, Armand STEPHAN, MOISSY-CRAMAYEL (FR)

(73) Assignee: SAFRAN POWER UNITS, TOULOUSE (FR)

(21) Appl. No.: 18/565,055

(22) PCT Filed: May 31, 2022
(86) PCT No.: PCT/EP2022/064675

§ 371 Date: Nov. 28, 2023

(30) Foreign Application Priority Data
Jun. 2, 2021 (FR) FR2105796

(51) Int. Cl. H01M 8/04089; H01M 8/0444; H01M 8/04746

(52) U.S. Cl. CPC H01M 8/04104; H01M 8/04455; H01M 8/04753; H01M 8/04776; H01M 2250/20

(57) ABSTRACT

Disclosed is a method for controlling a pressure regulating valve (6) for regulating the internal pressure (Pᵢₙₜ) of a fluid circuit (3) in an electrochemical device (2), said fluid circuit (3) being fed by a compressor (4) drawing air at an external pressure (Pₑₓₜ) and compressing same at the internal pressure (Pᵢₙₜ) according to a compression ratio (A); said method comprises a step of measuring the external pressure (Pₑₓₜ), determining an internal pressure set point (Pᵢₙₜ*) on the basis of the external pressure (Pₑₓₜ) measured and the compression range (B), so as to promote overall efficiency (R1) of the electrochemical device (2) and the compressor (4) according to the internal pressure (Pᵢₙₜ) and the compression ratio (A), and a step of controlling the pressure regulating valve (6) so as to reach the internal pressure set point (Pᵢₙₜ*).

### TECHNICAL FIELD

The present invention relates to the field of electrochemical devices (fuel cell, electrolyzer, etc.), in particular mounted on board an aircraft, and notably targets the regulation of the internal pressure in such an electrochemical device.

In a known manner, a fuel cell makes it possible to produce electrical energy from a redox reaction between a fuel, hydrogen, and an oxidizer, the oxygen in the air. With reference to FIG. 1, a fuel cell 200 comprises a stack of a plurality of cells 210, in which the redox reaction takes place, which are maintained between two end plates 220 making it possible to collect the electrical energy produced. The fuel cell 200 also comprises a cathode circuit 300 and an anode circuit 310 making it possible to supply the cells 210 with air and hydrogen respectively and to evacuate the products of the redox reaction, namely water and traces of hydrogen and air.

In the context of a fuel cell 200 mounted on board an aircraft, the air of the cathode circuit 300 is conventionally taken inside or outside the aircraft, namely in an external environment of which the physical-chemical properties are variable as a function of the altitude. In particular, the air pressure, called external pressure Pₑₓₜ, decreases with altitude and reaches, for example, around 9000 Pa at a high aircraft altitude of 17000 m. The same applies for the temperature and the oxygen concentration of the air notably. Such variations modify the operating conditions of the fuel cell 200 and may reduce its performances, which is undesirable.

To control the operating conditions of the fuel cell 200, it is known to mount a compressor 400 upstream of the cathode circuit 300 and a valve for regulating 600 the internal pressure downstream of the cathode circuit 300. As shown in FIG. 1, the compressor 400 makes it possible to compress the air taken from the external environment to inject it into the cathode circuit 300 according to an imposed mass flow rate Qₒₚₜ and internal pressure Pₒₚₜ making it possible to optimize the performance of the fuel cell 200. The regulating valve 600 comprises for its part a variable passage section in order to maintain the imposed internal pressure Pₒₚₜ in the fuel cell 200 to optimize the efficiency thereof. An embodiment according to the same principle is known from the patent application FR3074363A1.

However, in practice, the variation of the external pressure Pₑₓₜ during the flight of the aircraft requires the dimensioning of the compressor 400 with a wide compression ratio range to maintain optimum performance for the fuel cell 200. Such a dimensioning of the compressor 400 undesirably increases its mass, its bulk and its cost.

Furthermore, optimizing the efficiency of the fuel cell 200 requires a high electrical consumption of the compressor 400, notably at high altitude. The compressor 400 being conventionally electrically supplied by the fuel cell 200, it results that the gain in electrical production of the fuel cell 200 intended to supply the aircraft is at least partially lost by the electrical consumption of the compressor 400.

To eliminate these drawbacks, one solution would be to reduce the value of the imposed internal pressure Pₒₚₜ in the cathode circuit 300. However, this would reduce in an unacceptable manner the performances of the fuel cell 200.

The invention thus aims to eliminate at least some of these drawbacks by proposing a method and a module for controlling the valve for regulating the internal pressure in a fuel cell, and more generally in any electrochemical device, notably mounted on board an aircraft.

Fuel cells according to the prior art are known in the prior art by the patent applications US20190267645A1, WO2011089502A1 and US20080088043A1.

### BACKGROUND

The invention relates to a method for controlling a valve for regulating the internal pressure of a fluid circuit in an electrochemical device, said fluid circuit being supplied by a compressor configured to take the fluid at an external pressure and compress it to the internal pressure according to a compression ratio belonging to a predetermined compression range, said method comprising a step of controlling the regulating valve to reach a set internal pressure.

The invention is remarkable in that the method:
is implemented from predetermined data:
   the efficiency of the electrochemical device as a function of the internal pressure,
   the efficiency of the compressor as a function of the compression ratio,
   the overall efficiency as a function of the efficiency of the electrochemical device and the efficiency of the compressor, and
comprises:
   a step of measuring the external pressure, and
   a step of determining the set internal pressure from the measured external pressure and the compression range, so as to favor the overall efficiency.

The invention advantageously makes it possible to favor the overall efficiency obtained thanks to an electrochemical device, i.e., the efficiency of an electrical production system formed by the assembly of the electrochemical device as well as associated elements enabling its operation. The associated elements notably designate the compressor supplying the fluid circuit of the electrochemical device, the cooling circuit of the electrochemical device, etc. Such an overall efficiency is thus based on the electrical production of the electrochemical device, but also on the electrical consumption of its associated elements. This makes it possible to take into account the electrical power actually generated by the electrochemical device, corresponding to the electrical power that it generates less that it consumes to operate, directly or indirectly. Such an overall approach opposes the prior art aiming to favor the efficiency of the electrochemical device alone, without taking into account its associated elements.

To favor the overall efficiency, the invention advantageously proposes regulating in a simple and practical manner a single parameter, namely the internal pressure of the fluid circuit, by controlling the regulating valve mounted downstream. The determined set internal pressure is advantageously based on the physical-chemical data of the environment in which the electrochemical device is located, notably the external pressure, and on the performance data of the electrochemical device and its associated elements, notably the compressor.

According to one aspect of the invention, the step of determining the set internal pressure comprises:
a phase of calculating a test efficiency of the electrochemical device from a test internal pressure, said test internal pressure being calculated from the measured external pressure and from a predetermined compression test ratio belonging to the compression range so as to favor the efficiency of the compressor, and
as long as the test efficiency of the electrochemical device is below a predetermined minimum efficiency threshold, a new phase of calculating the test efficiency from a new incremented test compression ratio belonging to the compression range of the compressor,
the set internal pressure corresponding to the test internal pressure for which the test efficiency complies with the minimum efficiency threshold.

Such a test approach thus consists, from an acceptable hypothetical compression ratio for the compressor, in verifying that the efficiency of the corresponding electrochemical device is also acceptable. Such a test approach makes it possible to determine, from a simple measurement of the external pressure and performance data of the electrochemical device and its associated elements, an internal pressure value for which both the electrochemical device and its associated elements are in good operating conditions. In particular, the set internal pressure chosen at the end of the determination step ensures good efficiency of the electrochemical device while limiting the electrical consumption of the compressor. When the external pressure is modified, a new set internal pressure may be determined in a practical manner.

According to another aspect of the invention, the step of determining the set internal pressure comprises:
a phase of calculating a range of permissible internal pressures from the measured external pressure and the compression range, and
the overall efficiency being redefined thanks to the external pressure measured as a function of the internal pressure, a phase of maximization of the overall efficiency over the range of permissible internal pressures,
the set internal pressure corresponding to the permissible internal pressure for which the overall efficiency is maximum.

Such an optimization approach considers the efficiency of the electrochemical device as a function of the internal pressure and the compressor efficiency as a function of two variables, namely the internal pressure and the external pressure. From the measurement of the external pressure, the overall efficiency is rewritten as a function of the internal pressure and maximized over the range of permissible internal pressures. Such an approach advantageously makes it possible to determine the optimum operating point of the energy production system, which differs from that of the electrochemical device, notably when the external pressure is high, such as at high altitudes on board an aircraft.

According to one aspect of the invention, the efficiency of the electrochemical device is proportional to the internal pressure and the efficiency of the compressor is, at fixed external pressure, inversely proportional to the internal pressure. The determined set internal pressure is thus chosen sufficiently high to favor the performances of the electrochemical device, and sufficiently low to limit the energy consumption of the compressor.

According to one aspect of the invention, the electrochemical device is cooled by a cooling circuit having a predetermined efficiency as a function of the internal pressure, the overall efficiency being a function of the efficiency of the cooling circuit. The determined set internal pressure advantageously makes it possible to favor the operation of the energy production system as a whole, by considering the energy consumption of the compressor and the cooling circuit.

According to one aspect of the invention, the efficiency of the electrochemical device is a function of the level of oxygen in the fluid circuit, the control method comprising a step of measuring the level of oxygen in the fluid circuit, the determination step being implemented from the measured level of oxygen. The set internal pressure is advantageously determined from several physical-chemical conditions of the environment in which the electrochemical device is mounted, namely the external pressure and the level of oxygen present.

According to one aspect of the invention, the electrochemical device is in the form of a fuel cell and, preferably, the fluid circuit is in the form of a cathode circuit of the fuel cell, preferably in which air flows. The operating conditions of a fuel cell are advantageously based notably on the physical-chemical conditions of the external environment in which it is mounted, such as the external pressure of the air and its level of oxygen.

According to one aspect of the invention, the electrochemical device comprises a second fluid circuit of second internal pressure controlled by a second regulating valve, the control method comprising a step of controlling the second regulating valve to reach a second set internal pressure P10* verifying: |P10*−Pᵢₙₜ*|<S2, where S2 designates a predetermined maximum pressure variation threshold and Pᵢₙₜ* the set internal pressure of the first regulating valve of the first fluid circuit. The first fluid circuit and the first regulating valve here designate the fluid circuit and the regulating valve described previously, by distinction with the second fluid circuit and the second regulating valve. The method according to the invention thus makes it possible to control the internal pressure in both the oxidizer circuit and the fuel circuit of an electrochemical device. This makes it possible to ensure a substantially homogeneous pressure in the electrochemical device and thus guarantee its correct operation and increase its service life.

According to a preferred aspect of the invention, the second fluid circuit is in the form of a fuel cell anode circuit, preferably in which hydrogen flows. The method according to the invention thus makes it possible to control the internal pressure in both the oxidizer circuit and the fuel circuit of the fuel cell.

According to one aspect of the invention, the electrochemical device is mounted on board an aircraft to ensure at least in part its electrical energy supply, said method being implemented during the flight of the aircraft. The method according to the invention is particularly advantageous for an electrochemical device mounted on board an aircraft because the physical-chemical conditions vary significantly according to the altitude. The method according to the invention thus makes it possible to adapt the set internal pressure during flight to favor the overall efficiency regardless of the altitude of the aircraft.

The invention also relates to a module for controlling a valve for regulating the internal pressure of a fluid circuit in an electrochemical device for the implementation of the method as described previously, said fluid circuit being supplied by a compressor configured to take the fluid at an external pressure and compress it to the internal pressure according to a compression ratio belonging to a predetermined compression range, said control module comprising:
a member for measuring the external pressure,
a member for storing predetermined data:
   the efficiency of the electrochemical device as a function of the internal pressure,
   the efficiency of the compressor as a function of the compression ratio,
   the overall efficiency as a function of the electrochemical efficiency and the efficiency of the compressor,
a calculation member configured to determine a set internal pressure from the measured external pressure and the compression range, so as to favor the overall efficiency, and
a valve actuator of the regulating valve to reach the set internal pressure.

### BRIEF DESCRIPTION OF THE DRAWINGS

The invention will be better understood upon reading the following description, given as an example, and in reference to the following figures, given as non-limiting examples, wherein identical references are given to similar objects.

FIG. 1 is a schematic representation of a fuel cell mounted on board an aircraft according to the prior art.

FIG. 2 is a schematic representation of a fuel cell mounted on board an aircraft according to one embodiment of the invention.

FIG. 3 is a schematic representation of a method for controlling a regulating valve of the fuel cell of FIG. 2 according to one embodiment of the invention.

FIG. 4A is a schematic representation of a step of determining a set internal pressure of the method of FIG. 3 according to one embodiment of the invention.

FIG. 4B and FIG. 4C are schematic representations of a calculation phase during the implementation of the determination step of FIG. 4A.

FIG. 5A is a schematic representation of the step of determining a set internal pressure of the method of FIG. 3 according to an alternative embodiment of the invention.

FIG. 5B and FIG. 5C are schematic representations of the calculation phase during the implementation of the determination step of FIG. 5A.

FIG. 6A is a schematic representation of a fuel cell mounted on board an aircraft according to another embodiment of the invention.

FIG. 6B is a schematic representation of the method for controlling the regulating valve of the fuel cell of FIG. 6A according to another embodiment of the invention.

FIG. 7A is a schematic representation of a fuel cell mounted on board an aircraft according to another embodiment of the invention.

FIG. 7B is a schematic representation of the method for controlling the regulating valve of the fuel cell of FIG. 7A according to another embodiment of the invention.

FIG. 8A is a schematic representation of a fuel cell mounted on board an aircraft according to another embodiment of the invention.

FIG. 8B is a schematic representation of the method for controlling the regulating valve of the fuel cell of FIG. 8A according to another embodiment of the invention.

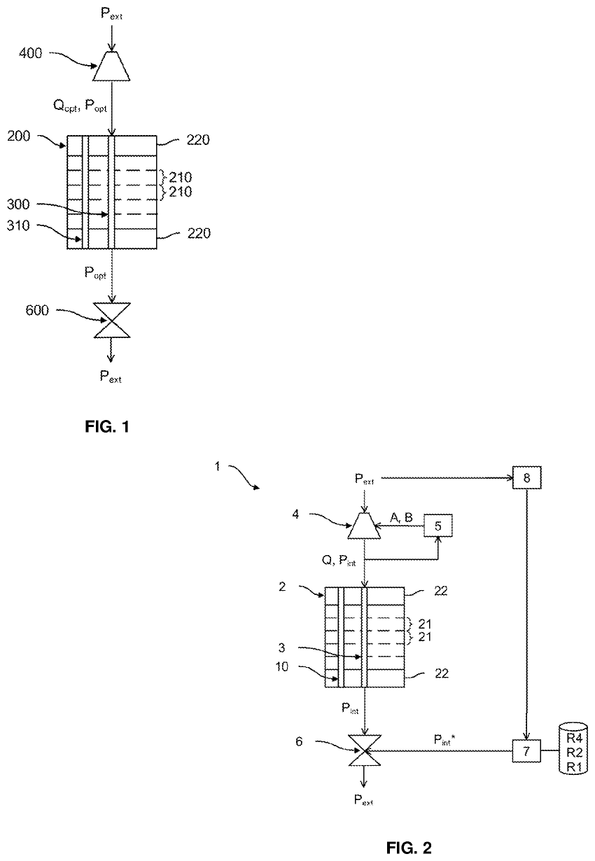

It should be noted that the figures set out the invention in detail in order to implement the invention, said figures may of course be used to better define the invention where applicable.

### DETAILED DESCRIPTION

The invention relates to a method for controlling a valve for regulating the internal pressure of a fluid circuit in an electrochemical device. The invention aims, in an environment of varying physical-chemical properties, to favor the efficiency of the electrochemical device on a global scale. The invention is subsequently described in the context of a fuel cell mounted on board an aircraft in order to regulate the internal air pressure in a fluid circuit in the form of a cathode circuit. However, it goes without saying that the electrochemical device could be in a form other than a fuel cell, such as an electrolyzer or a catalytic reactor, and/or be mounted in an environment different from that of an aircraft. The fluid circuit could also be in another form, such as an anode circuit, and/or allow the circulation of any fluid.

As described in the preamble, a fuel cell makes it possible to produce electrical energy from a redox reaction between a fuel, hydrogen, and an oxidizer, the oxygen present in the air. With reference to FIG. 2, a fuel cell 2 comprises a stack of a plurality of cells 21, in which the redox reaction takes place, which are held between two end plates 22 making it possible to collect the electrical energy produced. The fuel cell 2 also comprises a cathode circuit 3 and an anode circuit 10 making it possible to supply the cells 21 with air and hydrogen respectively and to evacuate the products of the redox reaction, namely water and traces of hydrogen and air.

As described in the preamble, in the context of a fuel cell 2 mounted on board an aircraft, the air of the cathode circuit 3 is conventionally taken inside or outside the aircraft, namely in an external environment of which the physical-chemical properties are variable as a function of the altitude. In particular, the air pressure, called external pressure Pₑₓₜ, decreases with altitude and reaches, for example, around 9000 Pa at a high aircraft altitude of 17000 m. The same applies for the temperature and the oxygen concentration of the air notably.

As described in the preamble and illustrated in FIG. 2, a compressor 4 and a regulating valve 6 are mounted respectively upstream and downstream of the cathode circuit 3. The compressor 4 and the regulating valve 6 together make it possible to control the internal pressure Pᵢₙₜ and the mass flow rate Q of the air in the cathode circuit 3, so as to control the operating conditions of the fuel cell 2. More precisely, the compressor 4 makes it possible to compress according to a compression ratio A the air taken from the outside environment at the external pressure Pₑₓₜ. The compression ratio A belongs to a compression range B that is specific to the compressor 4. The compression ratio A of the compressor 4 is controlled by a control device 5 according to the desired mass flow Q of air in the cathode circuit 3.

As described in the preamble and illustrated in FIG. 2, the regulating valve 6 comprises for its part a variable passage section controlled by a valve actuator 7 according to the desired internal pressure Pᵢₙₜ in the cathode circuit 3. The regulating valve 6 is thus pressure enslaved while the compressor 4 is flow rate enslaved, to control the operating conditions of the fuel cell 2 and consequently its efficiency.

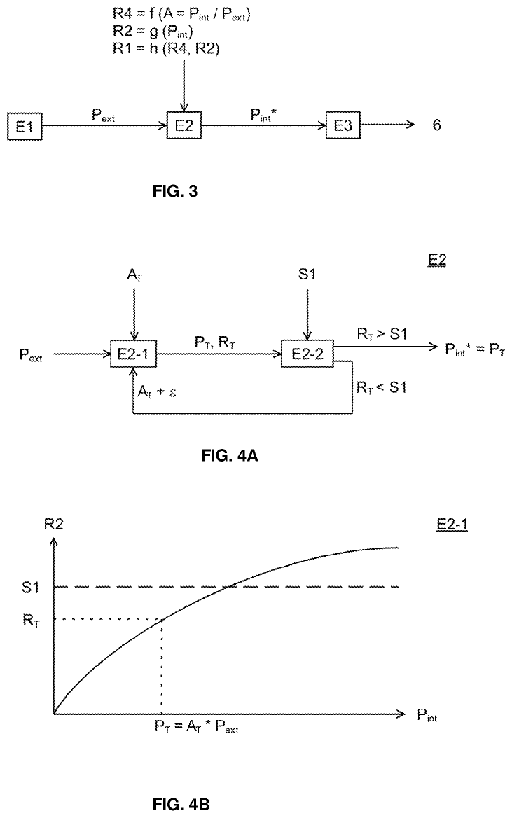

According to the invention and as illustrated in FIGS. 2 and 3, the internal pressure Pᵢₙₜ in the cathode circuit 3 is regulated by the implementation of a method for controlling the regulating valve 6 from predetermined data:
the efficiency R2 of the fuel cell 2 as a function of the internal pressure Pᵢₙₜ of the cathode circuit 3,
the efficiency R4 of the compressor 4 as a function of the compression ratio A, and
the overall efficiency R1 as a function of the efficiency R2 of the fuel cell 2 and the efficiency R4 of the compressor 4.

Still according to the invention and as illustrated in FIGS. 2 and 3, the control method comprises:
a step of measuring EI the external pressure Pₑₓₜ of the external air.
a step of determining E2 a set internal pressure Pᵢₙₜ* from the measured external pressure Pₑₓₜ and the compression range B of the compressor 4, so as to favor the overall efficiency R1, and
a step of controlling E3 the regulating valve 6 to reach the set internal pressure Pᵢₙₜ*.

As will be described hereafter, the determination step E2 is implemented, according to a first embodiment, by comparing the efficiency R2 of the fuel cell 2 for several internal pressure test values Pᵢₙₜ associated with an acceptable efficiency R4 of the compressor 4. According to a second embodiment, the determination step E2 is implemented by maximization of the overall efficiency R1 over a range of internal pressures Pᵢₙₜ acceptable for the compressor 4.

The control method according to the invention thus makes it possible to regulate the internal pressure Pᵢₙₜ in the cathode circuit 3 so as to favor the overall performances of an electrical production system 1. As illustrated in FIG. 2, such an electrical production system 1 encompasses the fuel cell 2 as well as the associated elements that enable its operation, such as the compressor 4 which supplies the fuel cell 2 with oxidizer The determined set internal pressure Pᵢₙₜ* thus makes it possible to favor the energy produced available for the aircraft, corresponding to the energy produced at the outlet of the fuel cell 2 from which is subtracted the energy consumed by its associated elements, such as the energy used to compress the external air.

The steps of the control method according to the first embodiment then according to the second embodiment of the invention are described below. Other preferred aspects of the invention are presented at the end.

As illustrated in FIG. 2, prior to the implementation of the control method, the data of the overall efficiency R1, the efficiency R2 of the fuel cell 2 and the efficiency R4 of the compressor 4 are stored in the valve actuator 7 of the regulating valve 6, or alternatively in any storage member, such as a database of a calculator. In practice, the efficiency data R1. R2, R4 are in the form of variables quantifying the energy performance of the considered system, namely its energy production and/or its energy cost, as a function of one or more parameters. According to a preferred aspect of the invention, one (or more) efficiency data R1, R2, R4 is in the form of:
the quotient of the power produced over the power consumed by the considered system; and/or
the deviation from a predetermined maximum efficiency of the considered system; and/or
the electrical power produced/consumed by the considered system.

It goes without saying that one or more of the efficiency data R1, R2, R4 could be in the form of another quantification variable of the energy performance than those mentioned.

According to a preferred aspect of the invention, the efficiency data R1, R2, R4 are in addition in the form of theoretical and/or experimentally obtained models that depend on one or more parameters. As illustrated in FIG. 3, the efficiency R4 of the compressor 4 varies as a function of the compression ratio A of the compressor 4, more precisely in an inversely proportional manner. It should be noted that, by definition, the compression ratio A of the compressor 4 verifies the relationship: A=Pᵢₙₜ/Pₑₓₜ. The efficiency R4 of the compressor 4 thus varies in an inversely proportional manner with the internal pressure Pᵢₙₜ, the external pressure Pₑₓₜ being fixed. Still with reference to FIG. 3, the efficiency R2 of the fuel cell 2 varies for its part as a function of the internal pressure Pᵢₙₜ, more precisely in a proportional manner. It goes without saying that additional parameters could be taken into account in the model of the efficiency R2 of the fuel cell 2 and/or the compressor 4, such as the oxygen content in the cathode circuit 3 for the efficiency R2 of the fuel cell 2, as will be described below.

As illustrated in FIG. 3, the overall efficiency R1 designates the efficiency of the electrical production system 1 previously defined as the assembly of the fuel cell 2 and associated elements enabling its operation. It is considered in this example that the electrical production system 1 is uniquely formed of the fuel cell 2 and the compressor 4. The overall efficiency R1 thus varies as a function of the efficiency R2 of the fuel cell 2 and the efficiency R4 of the compressor 4, in practice in a proportional manner. Preferably, the overall efficiency R1 corresponds to the quotient of the electrical power produced by the fuel cell 2 over the electrical power consumed by the compressor 4.

It goes without saying that other elements could be added to the electrical production system 1, such as the cooling circuit 9 of the fuel cell 2 as will be described hereafter. Preferably, the associated elements selected are those for which the energy consumption is a function of the operating conditions of the fuel cell 2, and in particular, the internal pressure Pᵢₙₜ of the cathode circuit 3. Preferably also, the associated elements selected are those for which the energy consumption is remarkable in comparison with the energy production of the fuel cell 2.

As shown in FIGS. 2 and 3, the control method starts with a step of measuring E1 the external pressure Pₑₓₜ of the external air. In this example, the measuring step E1 is implemented by a measuring member 8 connected to the valve actuator 7 of the regulating valve 6, preferably in the form of a pressure sensor. Alternatively, the external pressure P ext could be measured indirectly, for example from an altimetry sensor of the aircraft. At the end of the measurement step E1, the measurement of the external pressure Pₑₓₜ is transmitted to the valve actuator 7.

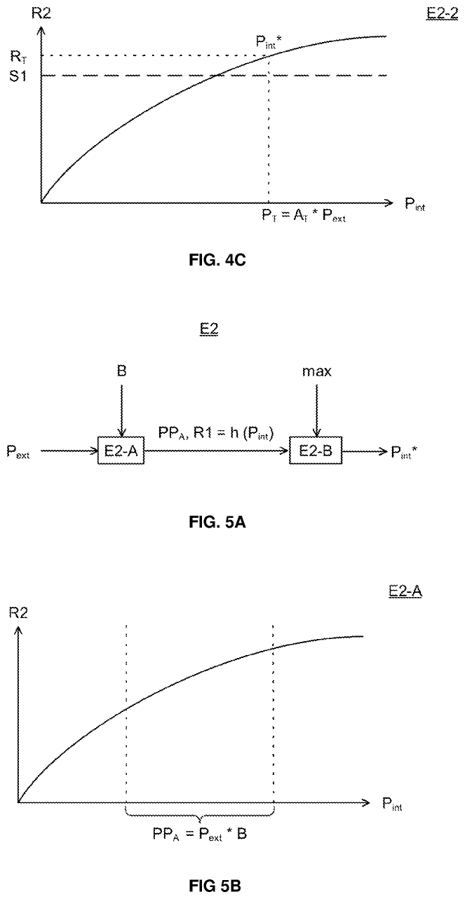

With reference to FIGS. 2 and 3, a step of determining E2 a set internal pressure Pᵢₙₜ* for the regulating valve 6 is next implemented. According to a first embodiment illustrated in FIG. 4A, the determination step E2 comprises:
a phase of calculating E2-1 a test efficiency R_{T} of the fuel cell 2 from a test internal pressure P_{T}, said test internal pressure P_{T} being calculated from the measured external pressure Pₑₓₜ and a predetermined test compression ratio A_{T} belonging to the compression range B so as to favor the efficiency R4 of the compressor 4, and
as long as the test efficiency R_{T} of the electrochemical device 2 is less than a predetermined minimum efficiency threshold S1, a new phase of calculating E2-2 the test efficiency R_{T} from a new incremented test compression ratio A_{T} belonging to the compression range B.

Thus, the set internal pressure Pᵢₙₜ* determined during the determination step E2 corresponds to the test internal pressure P_{T} for which the test efficiency R_{T} respects the minimum efficiency threshold S1.

In practice, as shown in FIGS. 4A and 4B, the calculation phase E2-1 is implemented from a predetermined test compression ratio A_{T} that belongs to the compression range B of the compressor 4. Preferably, the test compression ratio A_{T} is chosen low so as to correspond to a low energy consumption of the compressor 4 and consequently a high efficiency R4 of the compressor 4, verifying R4=f(A_{T})>S4. S4 designates a minimum efficiency threshold of the compressor 4, preferably less than the maximum efficiency of the compressor 4 by no more than 50%. Preferably, the test compression ratio A_{T} is also chosen lower than the median of the compression range B.

As shown in FIGS. 4A and 4B, during the calculation phase E2-1, the test internal pressure P_{T} associated with the test efficiency R_{T} is calculated from the measured external pressure Pₑₓₜ, in practice by the relationship: P_{T}=R_{T}×Pₑₓₜ. The test efficiency R_{T} of the fuel cell 2 is determined for its part from the predetermined efficiency R2 of the fuel cell 2 and the test internal pressure P_{T}, in practice by the relationship: R_{T}=R2=g(P_{T}). In the example of FIG. 4B, the test efficiency R_{T} obtained is lower than the minimum efficiency S1 of the fuel cell 2 such that a new calculation phase E2-2 is implemented with a new test compression ratio A_{T} incremented by an increment ε (see FIG. 4A).

FIG. 4C illustrates the calculation phase E2-2 with the new compression ratio A_{T}, in practice implemented in an identical manner to the previous one. In the example of FIG. 4C, the test efficiency R_{T} obtained during the calculation phase E2-2 is greater than the minimum efficiency threshold S1. No new calculation phase E2-1, E2-2 is then implemented and the set internal pressure Pᵢₙₜ* corresponds to the last test internal pressure P_{T} calculated, in this example during the calculation phase E2-2. It goes without saying that the number of calculation phases E2-1, E2-2 is arbitrary and notably depends on the test compression ratio A_{T} selected, the increment e and the minimum efficiency threshold S1. Preferably, the minimum efficiency threshold S1 of the fuel cell 2 is chosen below the maximum efficiency of the fuel cell 2 by no more than 50%.

Referring to FIGS. 2 and 3, at the end of the determination step E2, the set internal pressure Pᵢₙₜ* is transmitted to the valve actuator 7 so as to implement the step of controlling E3 the regulating valve 6. In the example of FIG. 2, the determination step E2 is implemented by the valve actuator 7, but it goes without saying that it could be implemented in any calculation member, connected to the member for storing predetermined data and to the valve actuator 7. The control step E3 is implemented for its part by regulating the passage section of the regulating valve 6 so as to obtain the set internal pressure Pᵢₙₜ* in the cathode circuit 3. Such a set internal pressure Pᵢₙₜ* makes it possible to both favor the electrical production of the fuel cell 2 and to limit the electrical consumption of the compressor 4. Preferably, such a control method is implemented several times during the flight of the aircraft, preferably at each change in altitude having an impact on the measured external pressure Pₑₓₜ.

Advantageously, the set internal pressure Pᵢₙₜ* is determined incrementally which meets the minimum efficiency objectives S1 while reducing the consumption of the compressor 4.

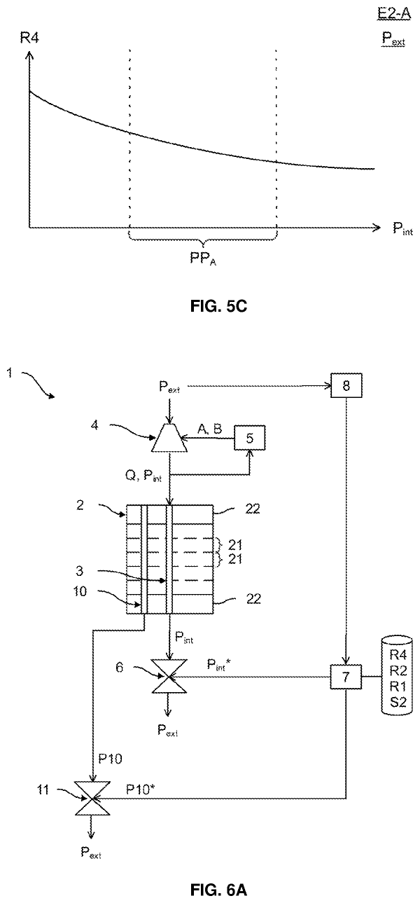

FIG. 5A illustrates a second embodiment of the invention that differs from the previous one in that the determination step E2 comprises:
a phase of calculating E2-A a range of permissible internal pressures PP_{A} from the measured external pressure Pₑₓₜ and the compression range B, and
the measured external pressure Pₑₓₜ making it possible to define the overall efficiency R1 as a function of the internal pressure Pᵢₙₜ, a phase of maximization E2-B of the overall efficiency R1 over the range of admissible internal pressures PP_{A}.

Thus, the set internal pressure Pᵢₙₜ* corresponds to the permissible internal pressure for which the overall efficiency R1 is maximum.

More precisely, with reference to FIGS. 5B and 5C, the range of permissible internal pressures PP_{A} determined during the calculation phase E2-A verifies the relationship: PP_{A}=Pₑₓₜ×B. The measured external pressure Pₑₓₜ also makes it possible to rewrite the efficiency R4 of the compressor 4 as a function of the internal pressure Pᵢₙₜ only. Thus, at the end of the calculation phase E2-A, as shown in FIGS. 5B and 5C, the efficiency R4 of the compressor 4 and the efficiency R2 of the fuel cell 2 are both as a function of the internal pressure Pᵢₙₜ. Consequently, the overall efficiency R1 may also be expressed as a function of the internal pressure Pᵢₙₜ only. In addition, the determined range of permissible internal pressures PP_{A} makes it possible to define the interval over which the overall efficiency R1 may be maximized.

As shown in FIGS. 5B and 5C, the maximization phase E2-B is implemented from the overall efficiency R1 and makes it possible to determine the set internal pressure Pᵢₙₜ* among the range of permissible internal pressures PP_{A} for which the overall efficiency R1 is maximum.

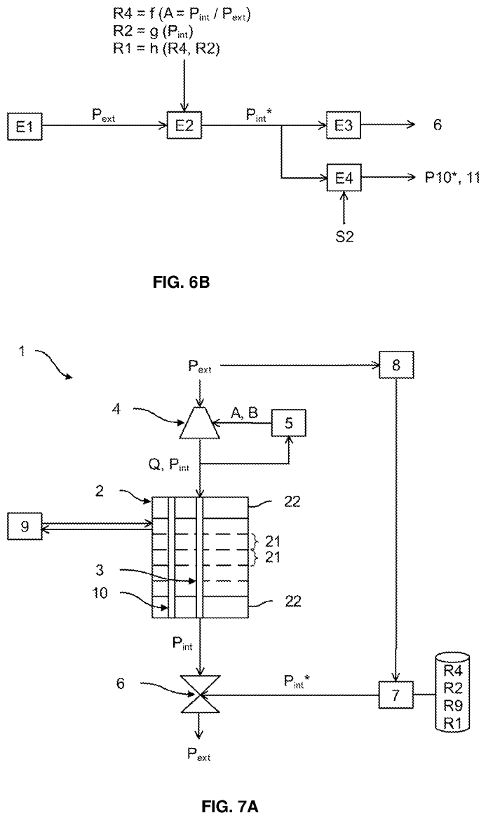

With reference to FIGS. 6A and 6B, according to a preferred aspect of the invention, the anode circuit 10 of the fuel cell 2 is also pressure enslaved. More precisely, as illustrated in FIG. 6A, a valve for regulating 11 the internal pressure P10 of the anode circuit 10 is mounted downstream of the anode circuit 10, hereinafter designated “second regulating valve 11”. For the sake of clarity, the regulating valve 6 of the cathode circuit 3 is for its part here designated “first regulating valve 6”. As illustrated in FIG. 6A, the second regulating valve 11 comprises a variable passage section controlled by the valve actuator 7, in this example identical to that of the first regulating valve 6, so as to obtain a second set internal pressure P10* in the anode circuit 10. For the sake of clarity, the set internal pressure Pᵢₙₜ* of the first regulating valve 6 is here designated “first set internal pressure Pᵢₙₜ*”.

As illustrated in FIG. 6B, the control method further comprises a step of controlling E4 the second regulating valve 11 to reach the second set internal pressure P10*, which verifies: |P10*−Pᵢₙₜ*|<S2, where S2 designates a predetermined maximum pressure variation threshold. This makes it possible to limit the pressure difference between the cathode circuit and the anode circuit, in order to increase the service life of the fuel cell 2.

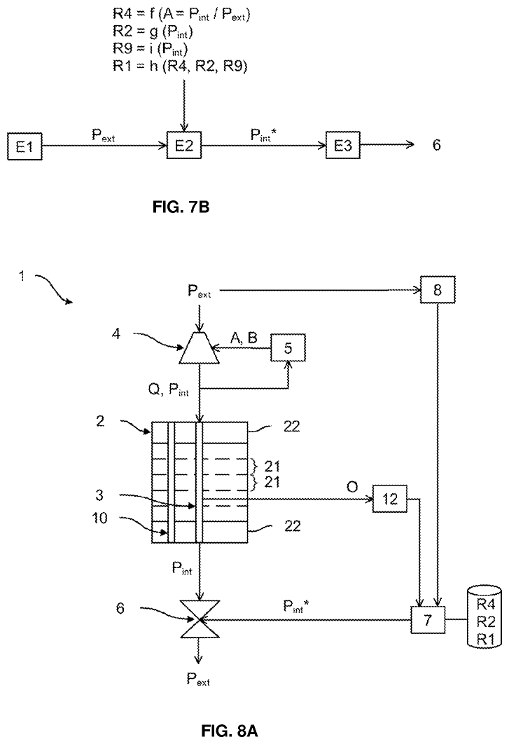

With reference to FIGS. 7A and 7B, according to another preferred aspect of the invention, the energy cost of the cooling circuit 9 of the fuel cell 2 is taken into account to determine the set internal pressure Pᵢₙₜ* of the regulating valve 6. More precisely, the control method is implemented from a predetermined datum of the efficiency R9 of the cooling circuit 9 as a function of the internal pressure Pᵢₙₜ of the cathode circuit 3. The overall efficiency R1 is for its part a function of the efficiency R2 of the fuel cell 2, the efficiency R4 of the compressor 4 and the efficiency R9 of the cooling circuit 9. In other words, the electrical production system 1 is formed of the fuel cell 2, the compressor 4 and the cooling circuit 9.

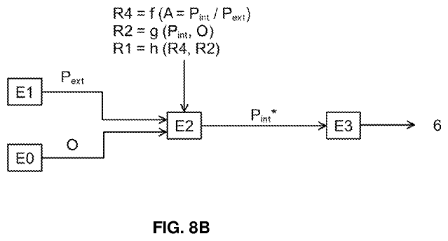

With reference to FIGS. 8A and 8B, according to another preferred aspect of the invention, the predetermined efficiency R2 of the fuel cell 2 also depends on the level of oxygen O in the air of the cathode circuit 3. The control method in addition comprises a step of measuring E0 the level of oxygen O in the cathode circuit 3, in this example by means of a dedicated measuring member 12 in the form of a gas sensor. The measurement step E0 is implemented in parallel with the step of measuring E1 the external pressure Pₑₓ and makes it possible to rewrite the efficiency datum R2 of the fuel cell 2 as a function of the internal pressure Pᵢₙₜ only. The taking into account of the level of oxygen parameter advantageously makes it possible to determine the set internal pressure Pᵢₙₜ* more reliably and precisely.

To conclude, the regulation of the internal pressure Pᵢₙₜ proposed in the invention corresponds to an unprecedented overall approach that takes into account the electrical production of the fuel cell 2, or more generally of an electrochemical device, but also the electrical consumption of its associated elements, in particular the compressor 4 but also the cooling circuit 9 by way of example. The determined set internal pressure Pᵢₙₜ* advantageously favors the overall efficiency of the electrical production system, based on the electrical production at the output of the fuel cell 2 minus the electrical consumption of its associated elements, such as the compressor 4. Such an overall approach differs from the prior art where the regulation of the internal pressure Pᵢₙₜ only took into account the performances of the fuel cell 2. Such a global approach also makes it possible, in particular, to reduce the dimensioning of the compressor 4 and consequently its mass and bulk on board the aircraft.

1. Method for controlling a valve for regulating the internal pressure (Pᵢₙₜ) of a fluid circuit in an electrochemical device, said fluid circuit being supplied by a compressor configured to take the fluid at an external pressure and compress it to the internal pressure according to a compression ratio belonging to a predetermined compression range, said regulating valve being mounted downstream of the fluid circuit, said method comprising a step of controlling the regulating valve to reach a set internal pressure (Pᵢₙₜ*) and wherein:
is implemented from predetermined data:
the efficiency of the electrochemical device as a function of the internal pressure (Pᵢₙₜ),
the efficiency of the compressor as a function of the compression ratio,
the overall efficiency as a function of the efficiency of the electrochemical device and the efficiency of the compressor, and
comprises:
a step of measuring the external pressure, and
a step of determining the set internal pressure (Pᵢₙₜ*) from the measured external pressure and the compression range, so as to favor the overall efficiency.

2. Method according to claim 1, wherein the step of determining the set internal pressure (Pᵢₙₜ*) comprises:
a phase of calculating a test efficiency of the electrochemical device from a test internal pressure, said test internal pressure being calculated from the measured external pressure and a predetermined compression ratio belonging to the compression range so as to favor the efficiency of the compressor, and
as long as the test efficiency of the electrochemical device is less than a predetermined minimum efficiency threshold, a new phase of calculating the test efficiency from a new incremented test compression ratio belonging to the compression range of the compressor,
the set internal pressure (Pᵢₙₜ*) corresponding to the test internal pressure for which the test efficiency respects the minimum efficiency threshold.

3. Method according to claim 1, wherein the step of determining the set internal pressure (Pᵢₙₜ*) comprises:
a phase of calculating a range of permissible internal pressures from the measured external pressure and the compression range, and
the overall efficiency being redefined thanks to the external pressure measured as a function of the internal pressure (Pᵢₙₜ), a phase of maximization of the overall efficiency over the range of permissible internal pressures,
the set internal pressure (Pᵢₙₜ*) corresponding to the permissible internal pressure for which the overall efficiency is maximum.

4. Method according to claim 1, wherein the efficiency of the electrochemical device is proportional to the internal pressure (Pᵢₙₜ) and the efficiency of the compressor is, at fixed external pressure, inversely proportional to the internal pressure (Pᵢₙₜ).

5. Method according to claim 1, wherein the electrochemical device is cooled by a cooling circuit having an efficiency predetermined as a function of the internal pressure (Pᵢₙₜ), the overall efficiency being a function of the efficiency of the cooling circuit.

6. Method according to claim 1, wherein the efficiency of the electrochemical device is a function of the level of oxygen in the fluid circuit, the control method comprising a step of measuring the level of oxygen in the fluid circuit, the determination step being implemented from the measured level of oxygen.

7. Method according to claim 1, wherein the electrochemical device is in the form of a fuel cell.

8. Method according to claim 1, wherein the electrochemical device comprises a second fluid circuit of second internal pressure controlled by a second regulating valve, the control method comprising a step of controlling the second regulating valve to reach a second set internal pressure (P10*) verifying: |P10*−Pᵢₙₜ*|<S2, where (S2) designates a predetermined maximum pressure variation threshold.

9. Method according to claim 1, wherein the electrochemical device is mounted on board an aircraft to ensure at least in part its supply of electrical energy, said method being implemented during the flight of the aircraft.

10. Module for controlling a valve for regulating the internal pressure (Pᵢₙₜ) of a fluid circuit in an electrochemical device for the implementation of a method according to claim 1, said fluid circuit being supplied by a compressor configured to take the fluid at an external pressure and compress it to the internal pressure (Pᵢₙₜ) according to a compression ratio belonging to a predetermined compression range, said control module comprising:
a member for measuring the external pressure,
a member for storing predetermined data:
the efficiency of the electrochemical device as a function of the internal pressure (Pᵢₙₜ),
the efficiency of the compressor as a function of the compression ratio,
the overall efficiency as a function of the efficiency of the electrochemical device and the efficiency of the compressor,
a calculation member configured to determine a set internal pressure (Pᵢₙₜ*) from the measured external pressure and the compression range, so as to favor the overall efficiency, and
a valve actuator of the regulating valve to reach the set internal pressure.
